(19) United States
(12) Patent Application Publication
(10) Pub. No.: US 2026/0248674 A1
(43) Pub. Date: Aug. 27, 2026

(54) LAMP URN FOR RETAINING CREMATION REMAINS AND FULLY FUNCTIONAL CERAMIC LAMP

(71) Applicant: Gloria Dobbs, Hendersonville, TN (US)

(72) Inventor: Gloria Dobbs, Hendersonville, TN (US)

(21) Appl. No.: 19/357,171

(22) Filed: Oct. 14, 2025

Related U.S. Application Data
(60) Provisional application No. 63/707,139, filed on Oct. 14, 2024.

(51) Int. Cl. A61G 17/08; A61G 17/007; F21S 6/00; F21V 23/00; F21V 23/06

(52) U.S. Cl. CPC A61G 17/08; A61G 17/007; F21S 6/002; F21V 23/002; F21V 23/06

(57) ABSTRACT

Although any container can claim to be used as an urn, in the case using any regular lamp leaching would occur. A second consideration is how to add cremains through a narrow opening. The 2-part container allows access to the cavity holding the sac, keeping the assembly of the electrical in place. This gives the user the ability to later remove a completely intact amount of cremains. An example would be for later distribution to other family members or if breakage occurs.

### BACKGROUND OF THE INVENTION

Cremation has been a well-used method of honoring the deceased since about 1000 BC, when it was used by the Greeks. The cremations were performed in an open ceremony and in some countries, continued to be performed in this manner. In the modern western regions, cremations are performed in ovens by crematories and remains are returned in a plastic bag and often plastic container through a funeral director.

With cremation on the rise, as it has increased tremendously over the past 10 years, and with population growth, plots with headstones in over-populated areas are becoming increasingly difficult to obtain within a reasonable distance of suburban areas. Also, in consideration is the cost involved in traditional burials versus cremation, which is but a fraction of the current cost.

Traditional cremation urns are creative and sometimes artistic but lack in function. Most urns are kept in the home and people often would like to display them in a meaningful way, but not done so tastefully.

### SUMMARY OF THE INVENTION

The primary objective was to provide a functional ceramic lamp that was artistic in beauty but will also hold remains safely in the event of breakage or if a transfer or distribution was later desired.

A further objective was to offer a discrete way to have remains in your home, but not necessarily in a memorialized manner, that could possibly be offensive to others either religiously or in presence of sensitively.

Additionally, it was desired to achieve a product that can be presented to the general public without requiring knowledge of electrical wiring, or difficulty in adding cremains.

### PRIOR ART

Display of cremation urns has been previously cited in various adaptations of urns that have light. For the purpose of this invention as it is described for suitable use in any setting that does not have the memorialized symbols, shape and non-functional aspects in tradition forms.

### BRIEF DESCRIPTION OF DRAWINGS

FIG. 1—Cross section of Ceramic Lamp in cross section showing the electrical components as well as the inner sac which would hold cremains.

FIG. 2—Sac which holds cremains, is shown laid out flat before insertion into Lamp

FIG. 2 inset—Sac as it sits inside the Lamp Urn.

### DETAILED DESCRIPTION OF THE INVENTION

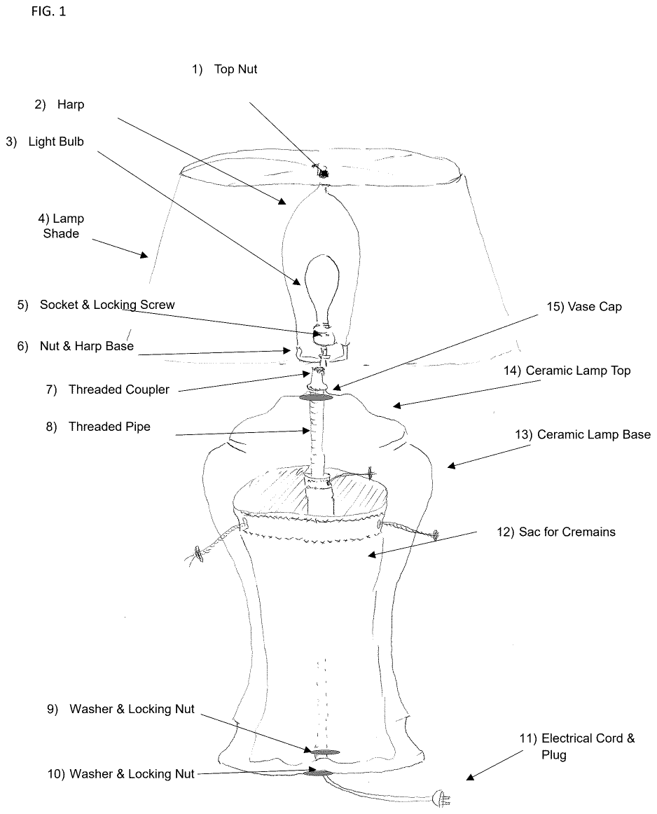

The base of the lamp (FIG. 1-13) and lamp top (FIG. 1-14) are made out of stoneware clay in and fired in a kiln for the first of 2 firings to temperature of 1832 degrees. It is then brushed or dipped in glaze and refired in the kiln to a temperature of 2232.

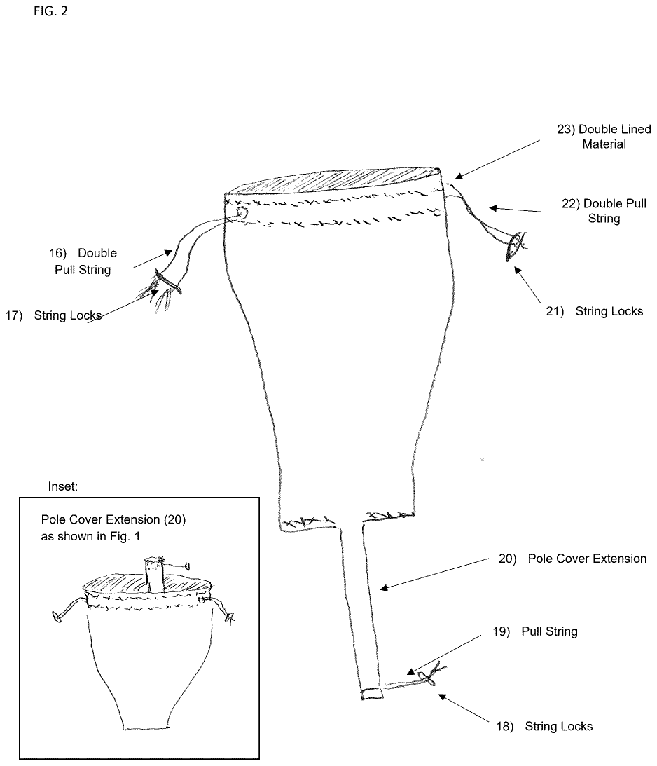

The satin sac (FIG. 1-12) is made from silk satin material and doubled then sewn along the bottom as shown in FIG. 2. In an hour-glass shape that fits into the lamp urn. The pole cover (FIG. 2-5) is sewn separately and attached at the bottom using a double Z stitch and overstitched straight stitching leaving access for the pole to enter thru (as shown in FIG. 2 inset drawing). Strings (FIG. 2-1 & 7) are threaded through the double stitching and string locks (FIG. 2-2 & 6) securing it with knots.

The lamp parts are then assembled in order as follows:

Inserting the threaded pipe (FIG. 1-8), the washer and locking nut (FIG. 1-10) are on the outside bottom and inside washer and locking nut (FIG. 1-9) securing the pole. The electrical cord (FIG. 1-11) is fed through the threaded pipe (FIG. 1-8). The sac FIG. 1-12) is then inserted into the ceramic base (FIG. 1-13). Adding the ceramic lamp top (FIG. 1-14) and vase cap (FIG. 1-15), then secured by a threaded coupler (FIG. 1-7).

Next would be a nut and harp base (FIG. 1-6), then the socket & locking screw (FIG. 1-5). At this point the electrical cord (FIG. 1-11) is attached to the socket (FIG. 1-5) using the screws provided on the socket assembly and using a underwriter's knot. The socket (FIG. 1-5) is put together securely and attached to the threaded pole (FIG. 1-8), held in place with a locking screw. The harp (FIG. 1-2) is added to the harp base, lamp shade and top nut.

When the end user would like to add the cremains, they will need to only partially disable in the reverse order, omitting the need for disconnecting the wiring. As follows, unscrew top not and remove lamp shade and harp. Then loosen the locking screw on the socket and gently pulling the electrical cord you can lay the assembled socket alongside the lamp urn.

Unscrew the threaded coupler and the vase cap and ceramic lamp top can lay alongside of the lamp urn. At this point, the sac (FIG. 1-12) is accessible and large enough to lift over the top of the edge of lamp base (FIG. 1-13). Cremains can then be added and by pulling the double strings (FIG. 2-1 & 7) on the sac and then using the string locks (FIG. 2-2 & 6) pull tightly against the Sac (FIG. 2-8) and lock in place, thus you will secure the cremains. Reassembly in the original order would be adding the ceramic lamp top (FIG. 1-14) and vase cap (FIG. 1-15). Securing these in place by screwing back the threaded coupler (FIG. 1-7) then nut & harp base (FIG. 1-6). Adding the already assembled socket (FIG. 1-5) is secured in place with the locking screw and the electrical cord (FIG. 1-11) is pulled to the original length. Finishing is adding the harp (FIG. 1-2), lamp shade (FIG. 1-4) and top nut (FIG. 1-1).

1. An illuminated cremation urn comprising:
a container defining an interior cavity configured to receive cremated remains;
a removable portion providing access to the interior cavity;
a liner positioned within the cavity and configured to securely contain the cremated remains; and
a lamp assembly integrated with the container, the lamp assembly including a socket, wiring, and a support structure arranged such that the electrical components remain in place during insertion or removal of the liner.

2. The cremation urn of claim 1, wherein the container is formed from a ceramic material selected from the group consisting of stoneware, porcelain, or earthenware.

3. The cremation urn of claim 1, wherein the liner comprises a double-lined fabric sac.

4. The cremation urn of claim 3, wherein the fabric sac is formed from silk satin or an equivalent textile material.

5. The cremation urn of claim 1, wherein the removable portion comprises a top portion of the container configured to interlock with or thread onto the base portion.

6. The cremation urn of claim 1, wherein the liner includes a drawstring closure with string locks to secure the cremated remains within the sac.

7. The cremation urn of claim 1, wherein the lamp assembly further comprises a threaded central pole extending through the cavity and coupled to the socket.

8. The cremation urn of claim 7, wherein the threaded pole is secured by washers and nuts on opposite sides of the ceramic base.

9. The cremation urn of claim 1, wherein the container is finished with a glaze applied after a high-temperature kiln firing.

10. The cremation urn of claim 1, wherein the lamp assembly includes a harp and lampshade mounted above the container.

11. The cremation urn of claim 1, wherein the liner is removable intact from the cavity to enable redistribution of the cremated remains to additional containers.

12. The cremation urn of claim 1, wherein the container is dimensioned and shaped to resemble a household lamp base.

13. The cremation urn of claim 1, wherein the lamp assembly includes an underwriter's knot securing the electrical cord to the socket connection.

14. The cremation urn of claim 1, wherein the container includes decorative features selected from the group consisting of glaze patterns, surface textures, or applied ornamentation.

15. The cremation urn of claim 1, wherein the lamp assembly and liner are arranged such that cremated remains can be added or removed without disconnecting the electrical wiring.

16. A method of storing cremated remains in an illuminated cremation urn, comprising: providing a container having an interior cavity and an integrated lamp assembly; placing a liner within the cavity, the liner configured to contain cremated remains; securing electrical components of the lamp assembly within the container; and adding cremated remains to the liner while maintaining the electrical components in an assembled state.

17. The method of claim 16, further comprising closing the liner with a drawstring and string lock to secure the cremated remains.

18. The method of claim 16, wherein the container is assembled from a base portion and a removable top portion that is detached to provide access to the cavity.

19. The method of claim 16, further comprising removing the liner intact from the cavity to redistribute cremated remains to another container.

20. The method of claim 16, wherein the liner comprises a double-lined textile sac that is inserted into the container prior to assembly of the lamp top portion.
